(19) United States
(12) Patent Application Publication
(10) Pub. No.: US 2009/0228330 A1
(43) Pub. Date: Sep. 10, 2009

(54) HEALTHCARE OPERATIONS MONITORING SYSTEM AND METHOD

(76) Inventors: Thanos Karras, Mount Prospect, IL (US); Milton Silva Craig, Hinsdale, IL (US)

Correspondence Address: W. EDWARD RAMAGE, COMMERCE CENTER SUITE 1000, 211 COMMERCE ST, NASHVILLE, TN, 37201, US

(21) Appl. No.: 12/350,933

(22) Filed: Jan. 8, 2009

Related U.S. Application Data
(60) Provisional application No. 61/019,653, filed on Jan. 8, 2008.

(51) Int. Cl. G06Q 10/00; G06Q 50/00

(52) U.S. Cl. 705/10; 705/11

(57) ABSTRACT

An automated and quantitative way to measure patient experience by tapping into existing hospital information systems and aggregating all pertinent information that impacts patient experience, and compiling this information into a meaningful patient experience index. Application of this method makes the calculation of a Patient Experience Index based on Key Performance Indicators available in real-time through the use of web technologies, smart phones, alert notification, and other access mechanisms enabling and empowering personnel to address their patient experience issues proactively in real-time.

This application claims priority to U.S. Provisional Patent Application No. 61/019,653, filed Jan. 8, 2008, entitled “Healthcare Operations Monitoring System and Method,” and is entitled to that filing date for priority. The complete disclosure, specification, drawings and attachments of U.S. Provisional Patent Application No. 61/019,653 are incorporated herein in their entirety by reference.

### FIELD OF INVENTION

This invention relates to a system and method for monitoring and managing healthcare operations.

### SUMMARY OF INVENTION

In one embodiment, the present invention comprises a method that automates patient experience measurement in a quantitative way with data that is normalized across populations. A Patient Experience Index (PEI) is automatically calculated—in real-time—based on patient experience-related Key Performance Indicators (KPIs). This removes human entry and data collection points.

In another exemplary embodiment, the present invention can integrate data from disparate information systems within a hospital or department environment; aggregate the data into a structured database model; provides complex event-correlation from the data to create the PEI KPI; and presents this KPI in a real-time manner on any web-enabled device. In addition, the system may provide alerts and early warnings so that personnel can take action before patient experience issues manifest into significant hospital problems.

In yet another embodiment, a method offers an automated and quantitative way to measure patient experience by tapping into existing hospital information systems and aggregating all pertinent information that impacts patient experience, and compiling this information into a meaningful patient experience index. Application of this method makes the PEI available in real-time through the use of web technologies, smart phones, alert notification, and other access mechanisms enabling and empowering personnel to address their patient experience issues proactively in real-time.

### DESCRIPTION OF THE DRAWINGS

FIG. 1 shows a diagram of a system in accordance with an exemplary embodiment of the present invention.

FIG. 2 shows another diagram of a system in accordance with an exemplary embodiment of the present invention.

FIG. 3 shows a health care enterprise network with components of a system in accordance with an exemplary embodiment of the present invention.

FIGS. 3 through 12 show a series of screenshots of a “dashboard” in accordance with an exemplary embodiment of the present invention.

FIG. 13 shows a number of pre-established KPIs in accordance with an exemplary embodiment of the present invention.

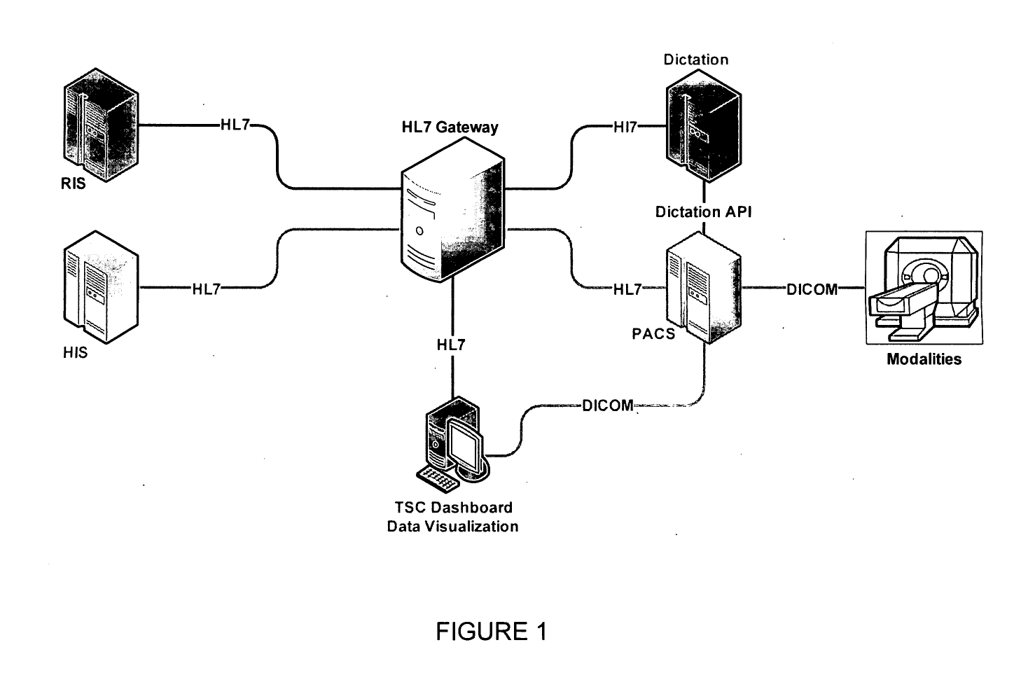

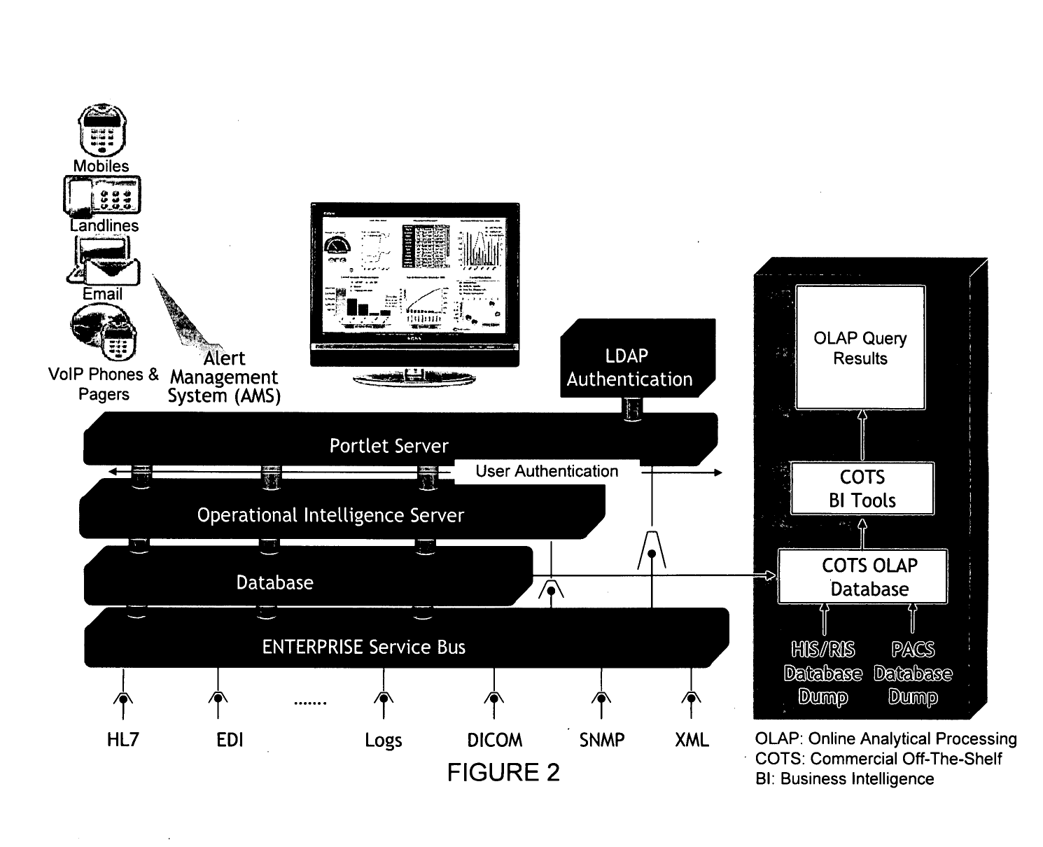

### DETAILED DESCRIPTION OF EXEMPLARY EMBODIMENTS

Most healthcare enterprises and institutions perform data gathering and reporting manually. Many computerized systems house data and statistics that are accumulated but have to be extracted manually and analyzed after the fact. These approaches suffer from “rear-view mirror syndrome”: by the time the data is collected, analyzed, and ready for review, the institutional makeup in terms of resources, patient distribution, and assets has changed.

As regulatory pressures on healthcare continue to increase, and with healthcare being under intense scrutiny, there is a need for understanding the real-time operational effectiveness of an enterprise and for addressing deficiencies immediately. This requires the ability to collect, analyze and review operational, actionable data from all aspects of an enterprise in real time. The data further needs to be reviewable by a director or c-level executive in an easily-understood manner in real time so that appropriate responsive action may be taken.

Key Performance Indicators (KPIs) are used by hospitals and similar institutions to measure operational performance and evaluate the patient experience. KPIs help healthcare institutions, clinicians, and staff provide better patient care, improve department and enterprise efficiencies, and reduce the overall cost of delivery. The process of compiling information into KPIs is time consuming and involves administrators and/or clinical analysts “running” individual reports on disparate information systems and manually aggregating this data into meaningful information.

For example, most radiology departments have an interest in monitoring technologist utilization. To compile this utilization data, a clinical analyst will have to run reports on a Picture Archiving and Communication System (PACS), on a Radiology Information System (RIS), and on a Time and Attendance system, and combine this data into a single piece of data, a KPI, that represents “technologist utilization.”

In one embodiment, the present invention comprises a method that automates patient experience measurement in a quantitative way with data that is normalized across populations. A Patient Experience Index (PEI) is automatically calculated—in real-time—based on patient experience-related KPIs. This removes human entry and data collection points.

In an exemplary embodiment, the present invention can integrate data from disparate information systems within a hospital or department environment; aggregate the data into a structured database model; provides complex event-correlation from the data to create the PEI KPI; and presents this KPI in a real-time manner on any web-enabled device. In addition, the system may provide alerts and early warnings so that personnel can take action before patient experience issues manifest into significant hospital problems.

The system receives, analyzes, and presents in a visual manner a variety of data derived from any data source in the healthcare enterprise or hospital. An intelligence engine “listens” to thousands of messages in the enterprise or hospital network, without impacting network performance. It recognizes and analyzes the data, and can present it in a variety of ways. In one exemplary embodiment, it presents a “dashboard” of visual, actionable indicators.

As an enterprise information enabler, the system listens to data unobtrusively, analyzes it, and incorporates it into reports and “dashboards” in real-time, for use by a variety of individuals, including, but not limited to, directors, managers, technologists, radiologists, clinicians of all types, and corporate executives. By presenting information in real-time, the system enables users to make decisions rapidly, and become proactive instead of reactive.

The system combines enterprise data visualization with select value acceleration services that help healthcare providers achieve clinical and operational efficiencies. Operating metrics and KPIs are gathered in real-time, analyzed, organized and formatted in a manner that eliminates hours of manual data gathering and analysis, thereby empowering the user to take immediate action, effectively modify resource behavior, make informed decisions, and/or adjust clinical and operational practices.

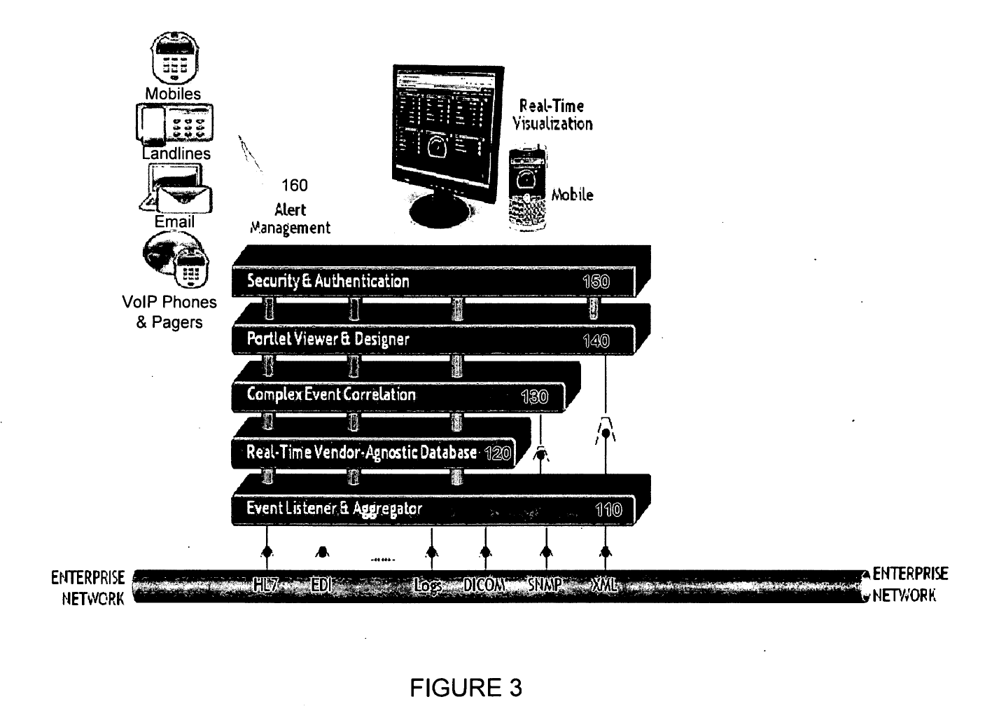

FIG. 3 shows an example of a Hospital Information System (HIS) on a hospital enterprise network where thousands of packets of information are communicated every instant. These pieces of information may be based on various standards applicable at the time, such as, but not limited to, HL7 and DICOM, or might be triggered through specific database queries initiated to retrieve pertinent data to a particular search. A system in accordance with one exemplary embodiment of the present invention may comprise the following components:

Event Listener and Aggregator 110, which listens to traffic on the enterprise network and aggregates data across multiple sources.

Real-Time Agnostic Database 120, which encapsulates a vendor-neutral or vendor-agnostic database and make it vendor agnostic. Databases such as MySQL, Oracle, Sybase, SQL Server, and the like can be used.

Complex Event Correlation 130 correlates data across multiple data sources and compiles them into actionable information.

Portlet Viewer and Designer 140 provides a web-based user interface.

Security & Authentication 150 provides user access controls.

Alert Management 160 provides alerts to key personnel when a PEI is outside the hospital or enterprise guidelines.

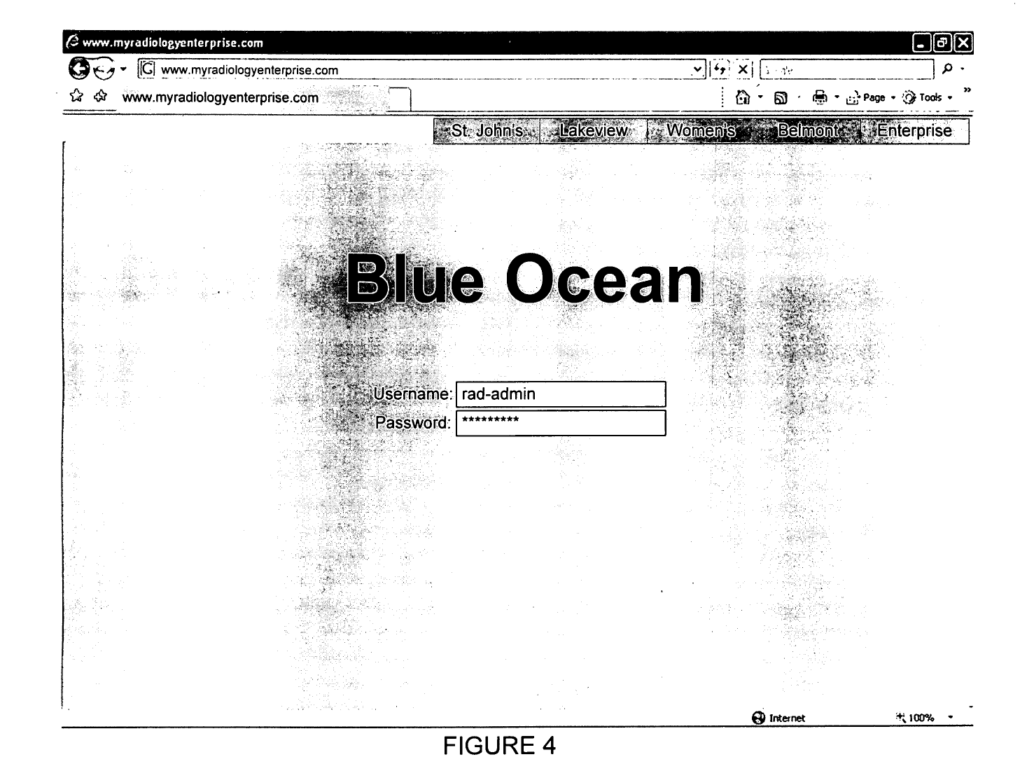

In one exemplary embodiment, as shown in FIGS. 4 through 13, data may be presented in “dashboard” fashion on a computer screen. Information can be presented at many different levels, giving the user the option to “drill down” and look at the smallest atom of information.

KPIs comprise performance metrics. KPIs can be standard for an industry or business, but also may include some that are specific to an institution or location. The system uses and presents these metrics to users to measure and demonstrate the overall performance of departments, systems, and individuals. KPIs include, but are not limited to, patient wait times (PWT), turn around time (TAT) on a report or dictation, stroke report turn around time (S-RTAT), or the overall film usage in a radiology department. For dictation, the system can measure the time from completed to dictated, time from dictated to transcribed, and time from transcribed to signed. Embodiments of the present system may have a number of pre-established KPIs built-in, such as those shown in FIG. 14, but individualized KPIs can be created as needed.

Once the KPIs are set, the performance of the system, department or individual is measured continuously in real-time. Certain KPIs can be considered critical performance indicators. In one exemplary embodiment, critical performance indicators include, but are not limited to, STAT orders. The system may utilize an advanced alert management system to deliver alerts to the right device, person, or role.

The present invention may highlight and trigger actions in response to various conditions, such as, but not limited to, long patient wait times, a modality that is underutilized, a report for stroke, a performance metric that is not meeting hospital guidelines, or a referring physician that is continuously requesting films when exams are available electronically through a hospital portal. Performance indicators addressing specific areas of performance can be acted upon in real-time, thereby positively impacting patient care, safety and satisfaction.

In one embodiment, a method in accordance with the present invention may be carried out as follows:

1. For each department, identify the KPIs that will be used to calculate the PEI. (E.g., for a radiology department, patient report turnaround time (RTAT) and patient wait time in the emergency department (EDWT) may be selected as significant KPIs).

2. Decompose each KPI to its primary components. (E.g., determine the two components needed to calculate the RTAT KPI (RTAT_KPI); the time the report was available for the radiologist to read, and the time the diagnostic report was signed by the radiologist.)

3. Listen to network traffic, including HL7, DICOM, and other related data sources, as needed. (E.g., for RTAT_KPI, listen for “exam complete” and “exam signed” messages within segments of the HL7 stream or function as DICOM PPS Server monitoring exam status.)

4. Automatically aggregate data across and calculate the KPI. (E.g., RTAT_KPI=time the report was signed−time the exam was available to read).

5. For each KPI, assign target ranges to signify operation in “green”, “yellow”, or “red” zones, or the equivalent. (E.g., RTAT Green<24 hrs, 24 hrs<=RTAT Yellow<=48 hrs, and RTAT Red>48 hrs.)

6. Calculate the PEI by assigning weight factors to each KPI. based on the relevant importance of each KPI. PEI may be normalized to a predefined scale factor. (E.g., PEI=W1*RTAT_KPI+W2*EDWT_KPI, where W1+W2=1.)

7. Assign target ranges to signify PEI is “green”, “yellow”, and “red” zones, or the equivalent.

8. Present a PEI visual indicator in real-time using an Internet or web-based application.

9. Alert key personnel via SMS, e-mail, page, or other communications method if PEI falls below hospital established standards (i.e., is in a red zone, or in a yellow zone).

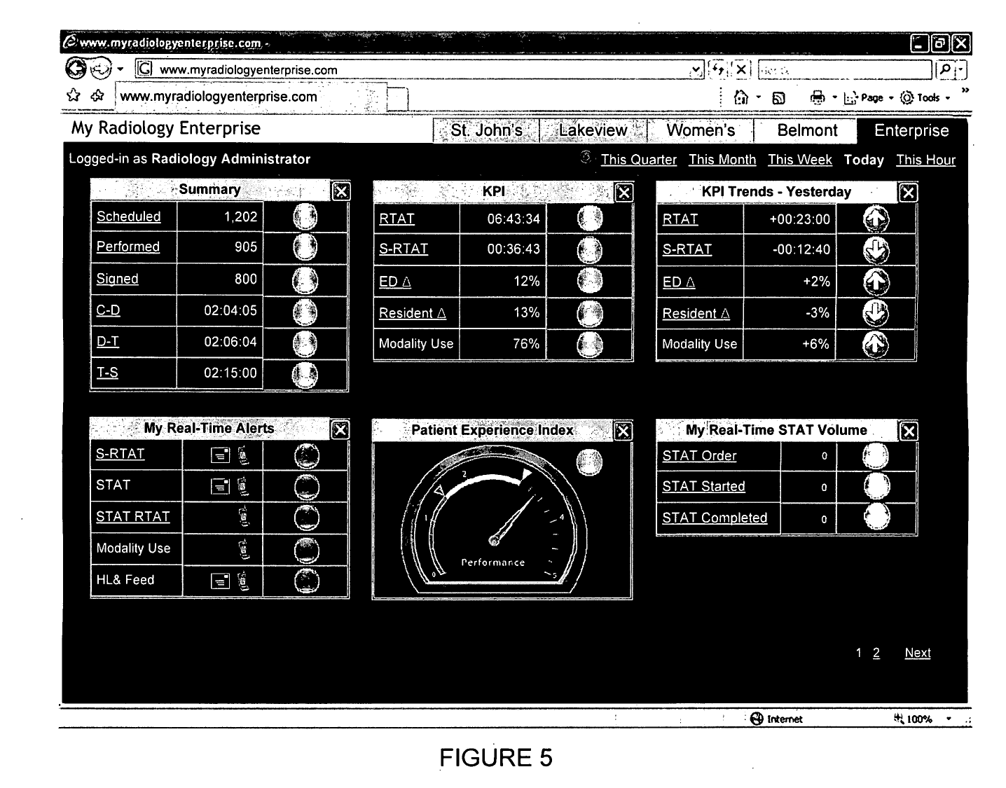

FIGS. 4 through 13 show an example of a Internet web-based visual “dashboard” presentation of information and a user's ability to “drill down” in response to an alert. FIG. 4 shows a log-in page. Upon logging in as a radiology administrator, the user is presented with a dashboard as seen in FIG. 5. Across the top are tabs that can be clicked on to show individual hospitals (e.g., St. John's, Lakeview, Women's, Belmont) or the entire enterprise. FIG. 4 shows the total data for the enterprise. The summary box shows the number of exams scheduled, performed, and dictated reports signed, as well as the average time from completion to dictation (C-D), from dictation to transcription (D-T), and from transcription to signing (T-S). The circles in the right column of the box are lights that show the status of that indicator based upon pre-determined parameters (e.g., green for good, yellow or amber for caution or possible problems, and red for an alert condition or existence of a significant problem). Other means of providing a visual alert can be used.

The KPI box in FIG. 5 shows the information for the KPIs listed (along with the light indicators), while the KPI Trends box shows a summary of these same KPIs since the previous day (i.e., yesterday). For the trends, the light indicators also may comprise a directional indicator (such as the arrows shown in FIG. 5), that indicate the direction of the trend.

Immediately above the trend box are a list of time periods that the user can click on to show data since the start of that period. As shown in FIG. 5, “Today” is clicked, showing data since the start of that day. Similarly, information can be presented for the year, the quarter, the month, the week, or the hour (or other time periods, as desired).

The “Real-Time Alert” box shows the indicators for which real-time alerts will be sent, and the icons (e.g., letter, phone) show how any alerts will be sent (e.g., email, cell phone). The “Real-Time STAT Volume” box shows a tally of STAT ordered, started and completed.

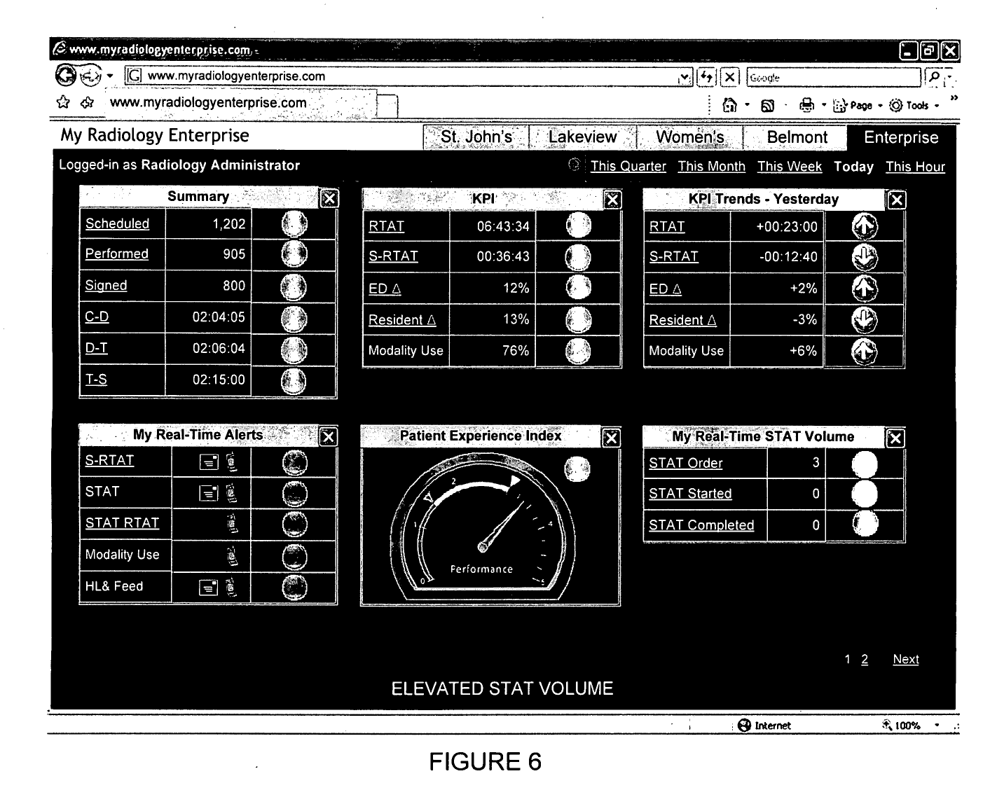

FIG. 6 also shows a dial representing the “Patient Experience Index.” The PEI is shown as a dial in this embodiment, although it can also be shown in a variety of other visualizations (e.g., chart, bars, graph, etc.). The PEI is automatically calculated based on selected KPIs, and can be calculated differently for different types of departments, institutions, etc. It relates individual KPIs to the impact that each KPI has on the customer experience and outcome in order of importance, with each KPI selected and weighted appropriately. This same calculation can be performed to determine a “Customer Experience Index” for different types of users and customers, e.g., referring physicians, customers, payors, vendors, distributors, and the like.

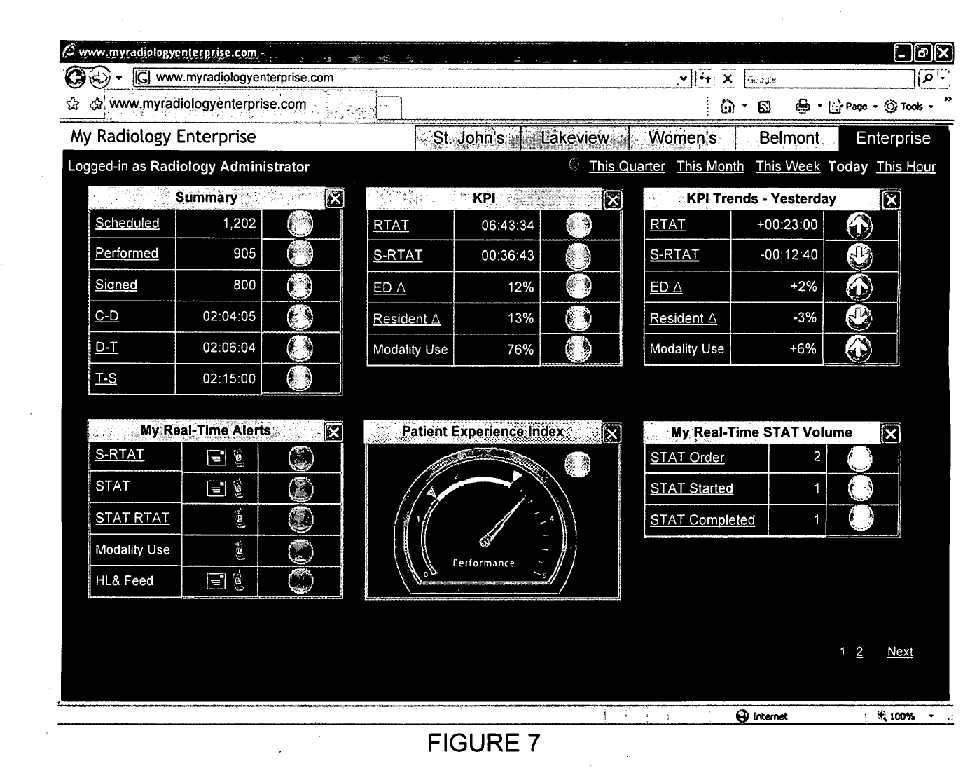

FIG. 7 shows a condition where 3 STAT orders have built up. An “ELEVATED STAT VOLUME” message, which can be yellow or amber in color (or some other suitable color), repeatedly scrolls across the bottom of the screen, and the two light indicators next to STAT Order and STAT Started turn yellow and begin flashing.

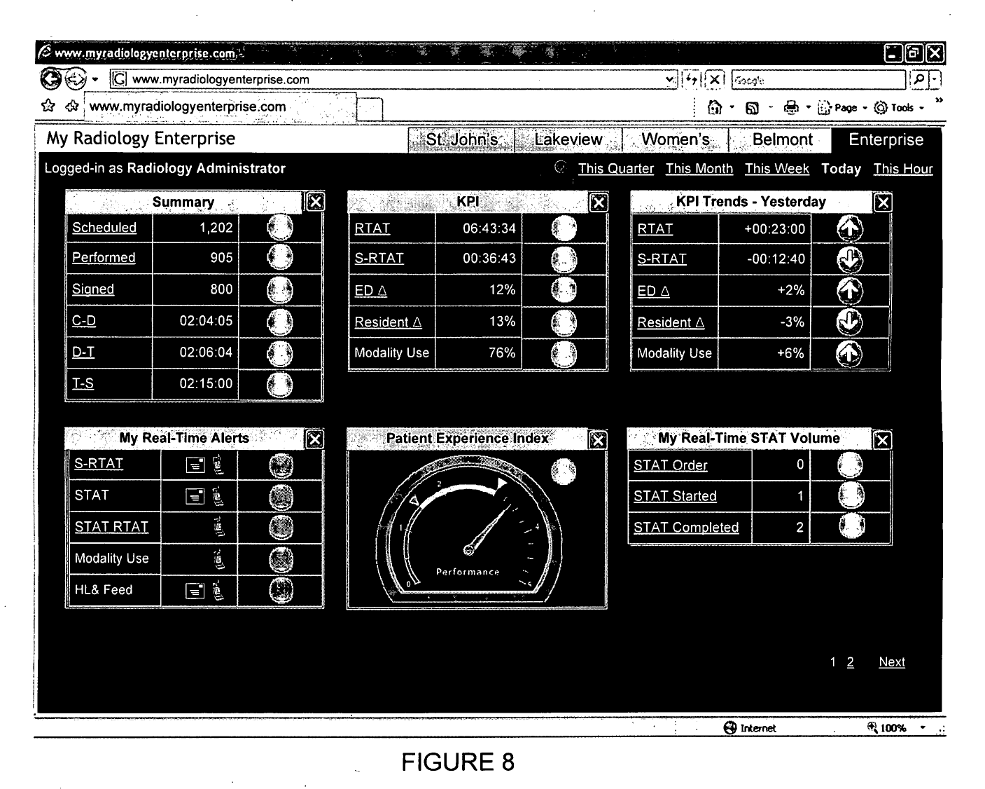

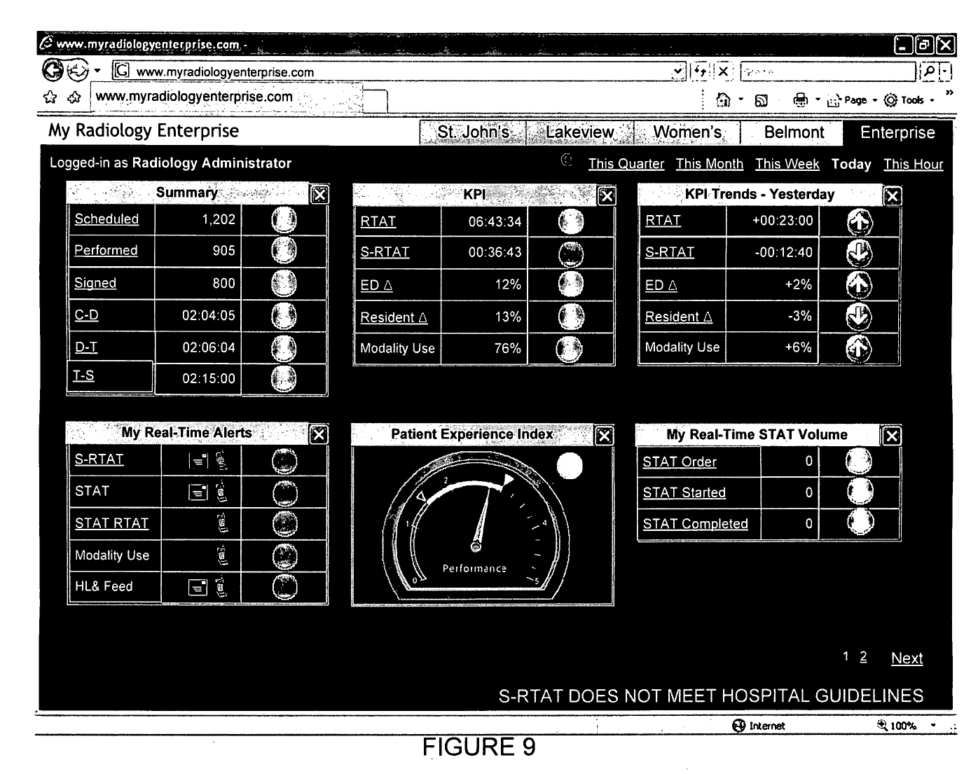

FIG. 8 shows where one of the three STAT orders has been started, one completed, and a new one has been added. The flashing yellow lights have now turned static and green, and the scrolling message has stopped. FIG. 9 shows a later view as the STAT orders work their way through the system.

In FIG. 9, a delay in processing appears in a sudden increase in the Stroke Report Turn Around Time (S-RTAT) by approximately 20 minutes. The light indicator by S-RTAT turns red and begins flashing. A matching “S-RTAT DOES NOT MEET HOSPITAL GUIDELINES” message (which can be red or some other color) scrolls across the bottom of the screen. In the “Real-Time Alert” box, the envelope and phone icons have turned red (and may flash) to indicate that an alert has been sent via those media, and the indicator light turns red and begins flashing. Flashing indicators may cease flashing after a set period of time, or upon some action being taken by the user.

FIG. 9 also shows the PEI gauge dropping into the yellow (or caution) range, reflecting the increase in S-RTAT.

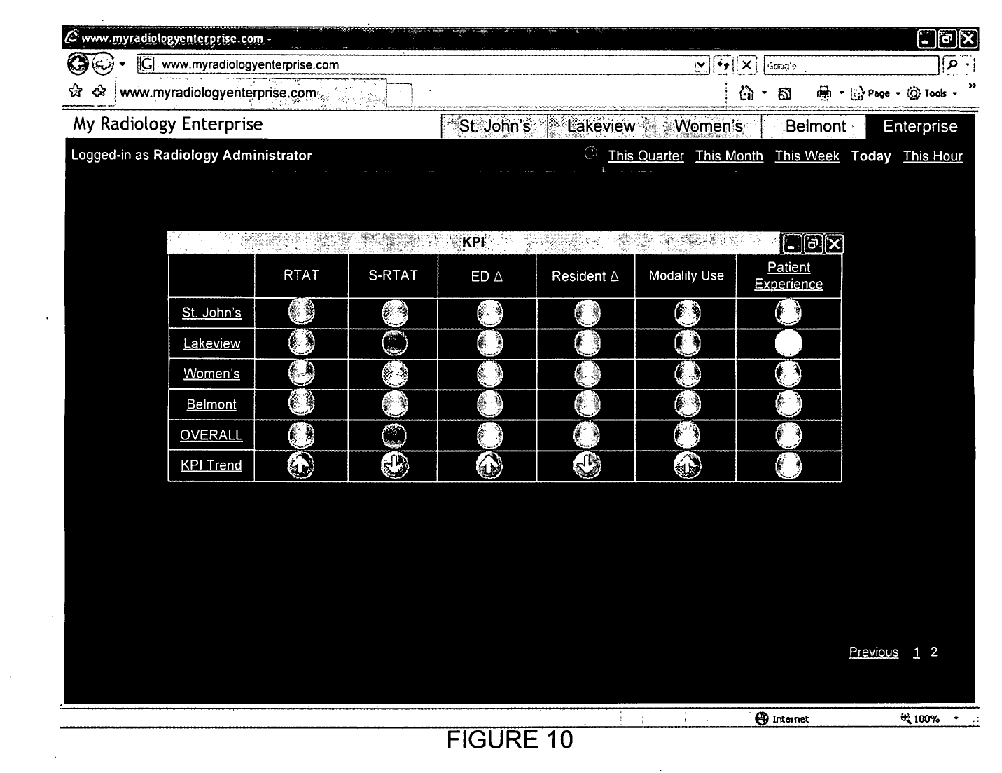

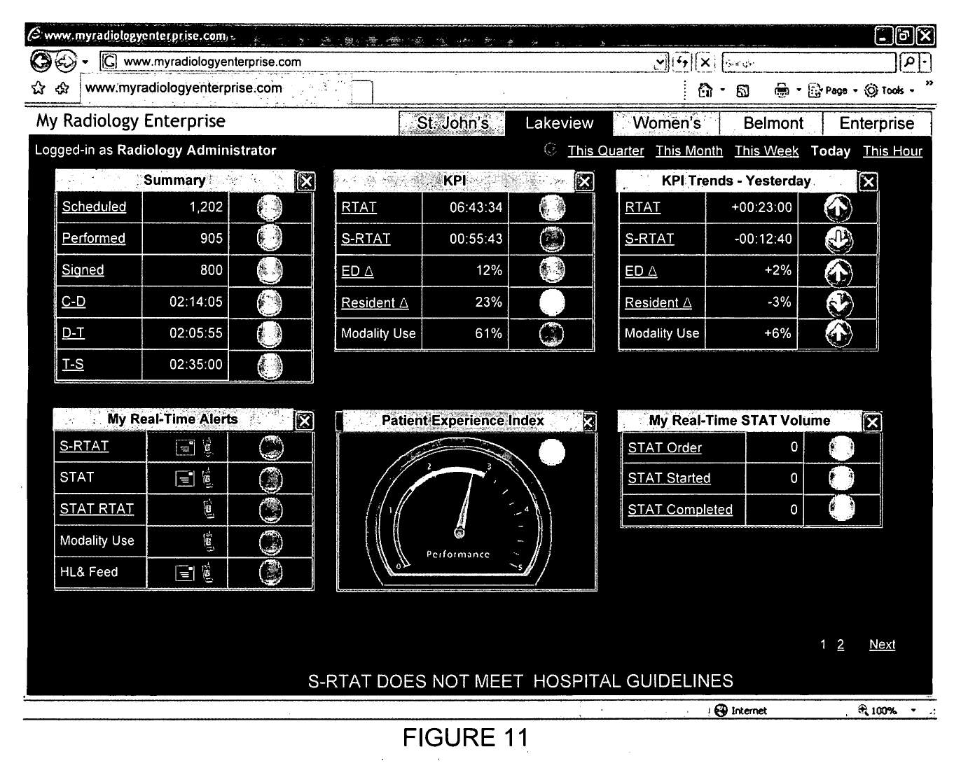

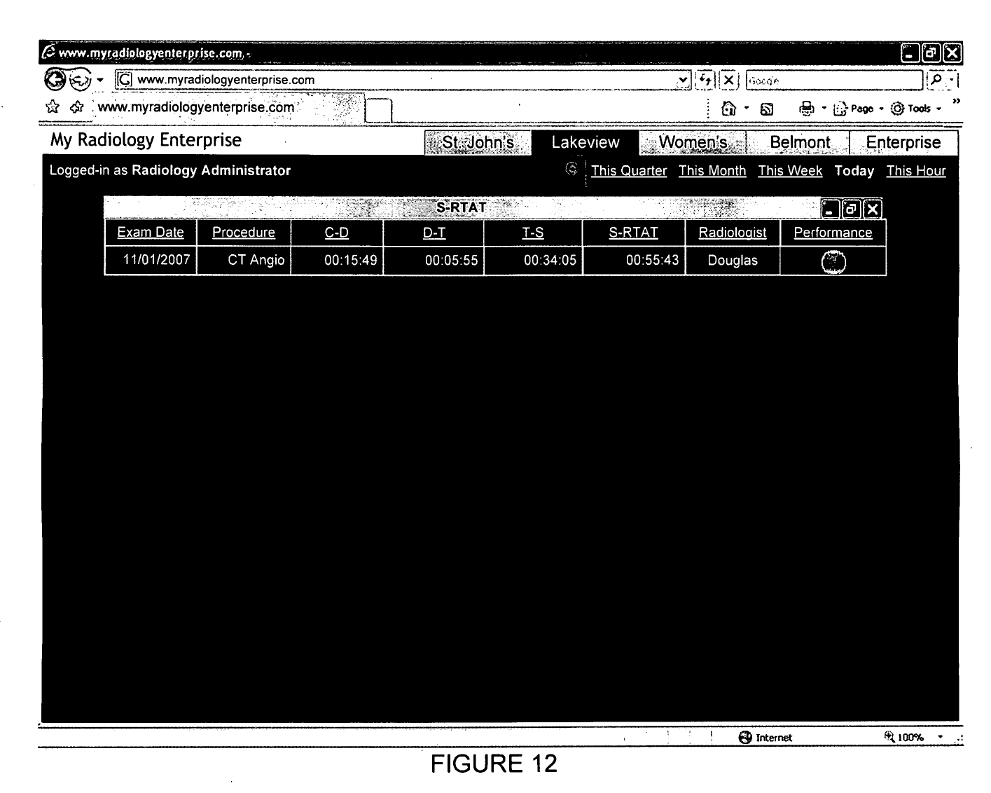

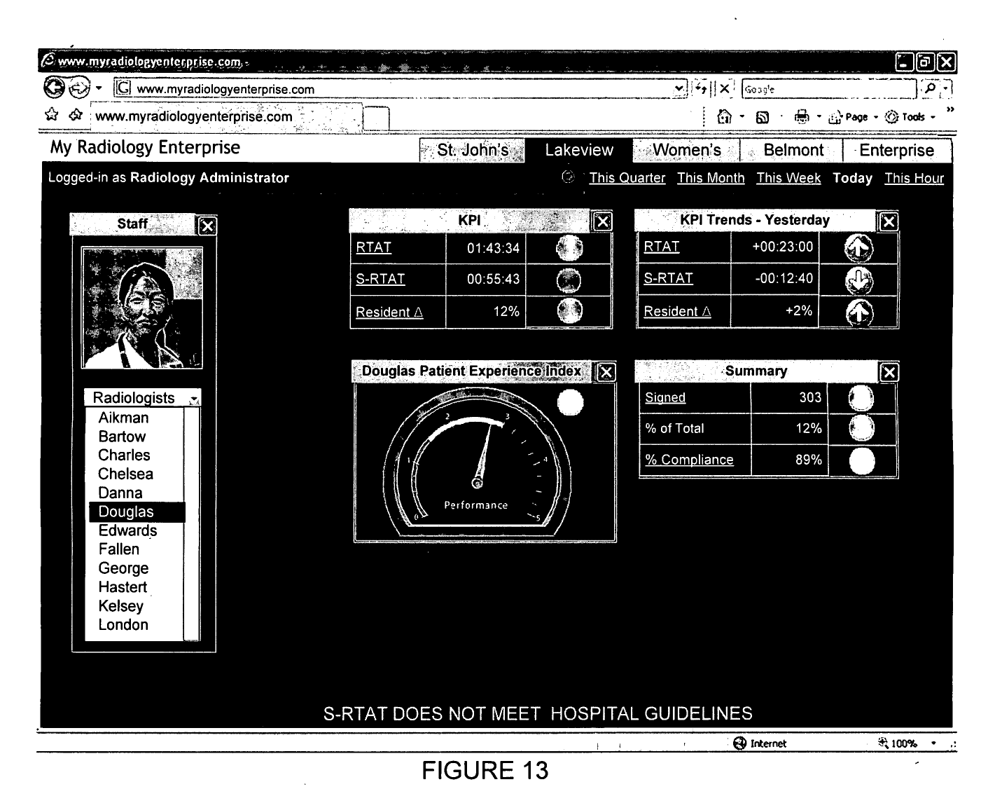

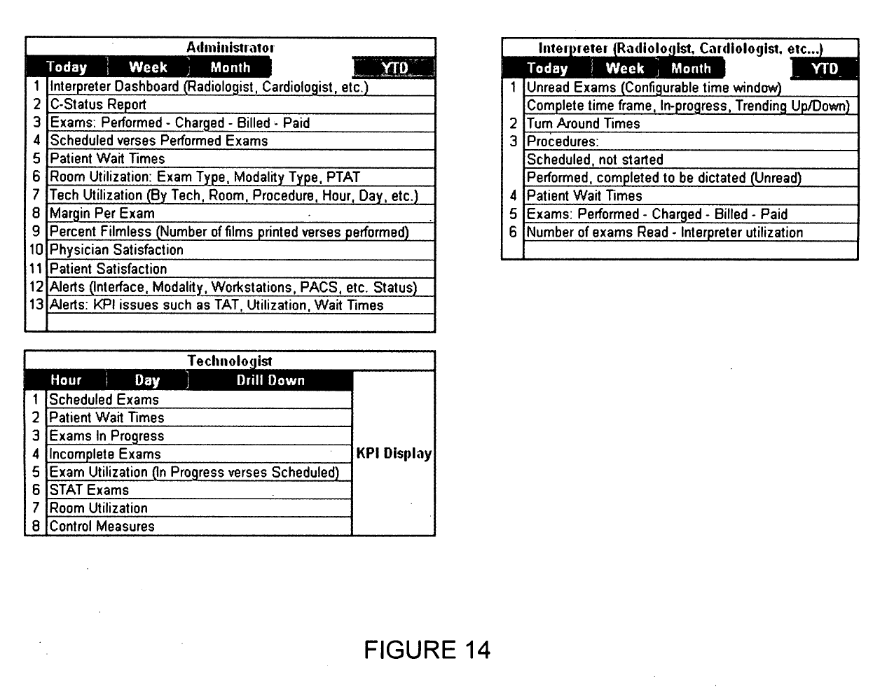

FIG. 10 shows how the user can “drill down” and view the KPI indicators for all hospitals in the enterprise in order to identify the source of the S-RTAT problem giving rise to the above alert. In this example, the indicator lights under S-RTAT are green for all hospitals except for Lakeview, which is red. Clicking on the Lakeview name in this screen takes the user to the Lakeview dashboard, seen in FIG. 11. Clicking on S-RTAT in the Lakeview dashboard screen gives more details, as shown in FIG. 12. In this example, the transcription to signing time (“T-S”) is high. Clicking on the radiologist's name takes the user to FIG. 13, which shows detailed information about the particular physician (including a PEI specific to the physician). The user can then contact the radiologist to address the problem immediately, in real-time.

The collection and presentation of this information provides business intelligence that can be utilized throughout the healthcare organization, and allows for “drill-down” to the lowest level of measurement from monitoring the overall performance of the enterprises. The system also allows for examination of the performance metrics of a single institution or department within the enterprise, as well as monitoring staff performance for each facility.

The system is configurable to meet the specific needs of various types of institutions. For example, at the enterprise level, users can monitor financial data from billing and cost tracking systems, average census information, number of admissions and discharges, and the length of stay. At the departmental level, users can monitor patient wait times, average number of exams performed, types of exams performed, dictation and report turn around times, and FTE utilization. At the individual level, the system can monitor the performance of staff, equipment and support systems, as well as overall patient, physician and employee satisfaction.

In one exemplary embodiment, the system has minimal or no impact on the organization or enterprise, as it passively listens and monitors messages on the enterprise IT network. In most cases, the system simply listens to transactions that occur. On occasion, it can query a system or receive data downloads. These latter activities typically are scheduled to occur off hours or at times that will have least impact on the network, users, and the processes.

In another exemplary embodiment, the system comprises an enterprise information enabler, a flexible and scalable platform that has unlimited expansion capabilities, and can be deployed to a specific clinical area, or expanded to all areas within a hospital. It is vendor independent, and offers monitoring of information pertaining to a variety of systems within the institution. The system provides automated reporting capabilities out of the box, although customized reports can be made. Users decide the type of report they would like to receive and the frequency of reporting. The system further provides trend forecasting and analysis.

In one exemplary embodiment, the system provides visualization of operational metrics within a department systems administration, and can integrate information from external systems such as a PACS, RIS, HIS, or other information source. KPIs include, but are not limited to, patient wait times, exam queues, film usage, exams dictated, and similar operational measurements. These are quantified, measured, and visually represented to the user, allowing for immediate action by the user and behavior modification within the department. The system thereby enhances the operational performance of the department, and helps to positively impact patient satisfaction, safety, performance, and efficiency.

In another embodiment, the system monitors financial performance based on efficiencies and overall improvements achieved through the above behavior modifications, actions, and departmental efficiencies. These include, but are not limited to, film cost savings, improved management of FTEs, reduced duplication of efforts within the department and facility as a whole, and more efficient scheduling of procedures and patients.

In yet another embodiment, the system may be used to monitor safety and compliance within a healthcare institution. Indicators monitored include, but are not limited to, ED discrepancy logging to meet JCAHO requirements, departmental Quality Assurance tracking, HIPAA logging, and billing compliance.

When standard KPIs are used, the system allows for benchmarking across institutions and even across enterprises or medical groups. KPIs thus can be used to compare operations between facilities that belong within the same healthcare enterprise, or between facilities in separate enterprises. The system also can monitor compliance with service level agreements with medical practices, and can permit institutions to monitor how a group is performing with regard to performance indicators, utilization of assets, and technology adoption.

In yet another exemplary embodiment, an Internet web site or system is provided for collaboration and sharing, where an online community can exchange KPIs.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

What is claimed is:

1. A computer-implemented system to monitor healthcare operations, comprising:
an event monitoring module, adapted to listen to information being communicated on a network and select certain data from said information;
a database for storing the selected data;
an event correlation module that analyzes the selected data and calculates one or more key performance indicators; and
a computer whereby one or more key performance indicators are displayed.

2. The system of claim 1, wherein the key performance indicators are displayed in a graphical user interface.

3. The system of claim 1, wherein an alert is given when one or more key performance indicators exceed a pre-established threshold.

4. The system of claim 1, further wherein a patient experience index is automatically calculated based upon one or more of the key performance indicators.

5. The system of claim 4, wherein the patient experience index is displayed in a graphical user interface.

6. The system of claim 4, wherein an alert is given when the patient experience index exceeds a pre-established threshold.

7. The system of claim 6, where the alert is sent to one or more designated recipients by email, SMS, or page.

8. A method to monitor healthcare operations, comprising the following steps:
automatically collecting data from a healthcare network;
automatically calculating one or more key performance indicators based on data collected from the network; and
automatically calculating a patient experience index based upon one or more key performance indicators, wherein said patient experience index is calculated by assigning pre-determined weight factors to the key performance indicators used in the calculation.

9. The method of claim 8, further comprising the step of displaying the key performance indicators and patient experience index on a computer display.

10. The method of claim 8, further comprising the step of providing an alert when the patient experience index or a key performance indicator exceeds a pre-established threshold.

11. The method of claim 10, further comprising the step of providing a graphical user interface permitting users to investigate the data used to calculate the key performance indicator or the patient experience index.
